(19) United States
(12) Patent Application Publication
(10) Pub. No.: US 2002/0011383 A1
(43) Pub. Date: Jan. 31, 2002

(54) Stairlift for the disabled

(76) Inventor: Gerd Grass, Detmold (DE)

Correspondence Address: LERNER AND GREENBERG, P.A., Post Office Box 2480, Hollywood, FL, 33022-2480, US

(21) Appl. No.: 09/899,695

(22) Filed: Jul. 5, 2001

(30) Foreign Application Priority Data
Jul. 5, 2000 (DE) 100 32 745.1

(51) Int. Cl. B66B 9/06; B61C 13/00; B61C 11/00; B66B 9/08

(52) U.S. Cl. 187/201; 187/200; 187/245; 105/29.1

(57) ABSTRACT

A stairlift has a vertically displaceable load-receiving device on which a platform, hinged ramps and barriers are disposed, vertically movable barrier-actuating bars, which protrude downward over the load-receiving device and individually link the barriers, a spring-loaded pretensioning device for the platform, which forces the platform upward, a tilt lever on the platform, which interacts with a tilt stop of the guide body and swings the platform up and down in the unloaded state, and two lifting bars linked to the platform, for interaction with rotating stops of the barriers in order to move the barriers out of the lowermost into the horizontal position as the unloaded load-receiving device is lowered.

### BACKGROUND OF THE INVENTION

### FIELD OF THE INVENTION

The invention relates to a stairlift, especially for wheelchair-bound disabled persons. The stairlift has a guide body, which is mounted such that it can be moved along a staircase. A load-receiving device is held in a vertically displaceable manner and is movable between a lowered stopping position and a raised travel position. The load-receiving device accommodates a swing-up platform, which has two swing-up hinged ramps and two separately operable, downward-swinging or upward-swinging barriers.

Previous stairlifts having a platform for receiving a wheelchair user have a lower and an upper guide, the upper guide simultaneously serving as a handrail. As the angle of inclination of the staircase increases, the guides have to be placed higher and higher to prevent the platform from jamming against the stairs, so that the standard measurements for a handrail were often exceeded and the interspace between the lower guide and the staircase additionally had to be covered by panels.

In more modern installations, in addition to the main motor there is also a spindle motor present for lowering the platform at the stopping places to allow a lower fitting of the guides. Such a system has a total of five motors (travel drive, vertical drive, floor and barrier drive).

German Patent No. DE 42 11 870 C2 discloses a stairlift having a load-receiving device, which is provided such that it is vertically displaceable relative to a guide bar mounted on guide rollers.

### SUMMARY OF THE INVENTION

It is accordingly an object of the invention to provide a stairlift which overcomes the above-mentioned disadvantages of the heretofore-known stairlift of this general type and which requires fewer drive motors and has a simplified electrical control system.

With the foregoing and other objects in view there is provided, in accordance with the invention, a stairlift, including:

a guide body to be mounted such that the guide body is movable along a staircase;

a load-receiving device held in a vertically displaceable manner, the load-receiving device being movable between a lowered stopping position and a raised travel position;

a swing-up platform provided at the load-receiving device, the swing-up platform having two swing-up hinged ramps;

two barriers provided at the load-receiving device, the barriers having respective pivot axles, the barriers being separately operable and being configured as selectively downward-swinging and upward-swinging barriers;

two vertically movable barrier-actuating bars provided at the load-receiving device, the barrier-actuating bars having respective end sections protruding downward beyond the load-receiving device when the load-receiving device is in the raised travel position, and the barrier-actuating bars being linked to the pivot axles of the barriers;

one of the barrier-actuating bars being moved upward and swinging a corresponding one of the barriers up such that the corresponding one of the barriers swings out of a substantially horizontal position into a substantially vertical position when the load-receiving device is lowered into the lowered stopping position and a respective one of the end sections protrudes downward and makes contact with a floor;

a pretensioning device operatively connected to the swing-up platform, the pretensioning device forcing the swing-up platform upward such that, when the swing-up platform is raised out of the lowered stopping position, the pretensioning device brings the swing-up platform into an upwardly inclined, vacant position, if the swing-up platform is in an unloaded state;

the guide body having a tilt stop the swing-up platform having a tilt lever disposed such that, when the swing-up platform is in an unloaded state and when the load-receiving device is one of raised into the travel position and lowered, the tilt lever interacts with the tilt stop of the guide body and swings the swing-up platform selectively up and down, and the tilt lever, when the swing-up platform is loaded and in the substantially horizontal position, remains disengaged from the tilt stop;

rotating stops disposed at the pivot axles; and

two lifting bars operatively linked to the swing-up platform, the lifting bars interacting with the rotating stops at the pivot axles of the barriers such that, when the load-receiving device is in an unloaded state and is lowered, with the swing-up platform initially being in a swung-up state and with the barriers initially being in a swung-down state, the lifting bars move the barriers into the substantially horizontal position as the swing-up platform is swung down.

In other words, the object of the invention is achieved by a stairlift, especially for wheelchair-bound disabled persons, having a guide body, which is mounted such that it is transportable along a staircase and on which a load-receiving device is held in a vertically displaceable manner and is movable between a lowered stopping position and a raised travel position, the load-receiving device accommodating a swing-up platform, having two swing-up hinged ramps, and two separately operable, downward-swinging or upward-swinging barriers,

the stairlift being characterized in that the load-receiving device accommodates two vertically movable barrier-actuating bars, which, in the travel position, respectively protrude with an end section downward over the load-receiving device and are respectively linked to a pivot axle of a barrier, one barrier-actuating bar, as the load-receiving device is lowered into the stopping position and the protruding end section makes contact with the floor, being moved upward and swinging the corresponding barrier up out of a horizontal position into a vertical position,

a pretensioning device forces the platform upward and, as this is raised out of the stopping position, brings it in the unladen state into a slightly upwardly inclined vacant position,

the platform has a tilt lever, which is provided such that, when the platform is unladen and as the load-receiving device is raised into the travel position, and also as it is lowered, it interacts with a tilt stop of the guide body and swings the platform up or down, whereupon the tilt lever, when the platform is laden and in the horizontal position, remains disengaged from the tilt stop, and

linked to the platform, especially to the tilt lever, there are two lifting bars, which interact with a respective rotating stop on the pivot axles of the barriers and, as the unladen load-receiving device is lowered, the platform initially being swung up and the barriers swung down, move the barriers into a horizontal position as the platform is swung down, and vice versa.

According to another feature of the invention, the barrier-actuating bars are provided respectively on the lower end section with a roller.

According to yet another feature of the invention, the pretensioning device has a spring-loaded stop, which, when the platform is swung down, interacts with the load-receiving device and forces the unladen platform upward.

According to a further feature of the invention, the tilt stop is configured as an engagement opening for the tilt lever.

The rotating stops are preferably provided on the pivot axles offset by 90° relative to the barriers.

Expediently, the barrier-actuating bars have a locking device, which in the travel position, when the barriers are horizontal, is snapped-in and prevents the barriers from being raised.

Preferably, the barrier-actuating bars are connected respectively by an interposed locking bar to the pivot axles, each locking bar having a locking projection for interaction with a projection of the load-receiving device.

Preferably, each locking bar has a sliding slope, which, as the barriers are moved out of the swung-up position into the horizontal position, moves the locking bar past the projection.

According to a preferred embodiment, each locking bar, when the barrier is in the horizontal position, assumes a slightly angled-off position relative to the barrier-actuating bar, so that, as the barrier-actuating bar is actuated, a transverse force is generated which moves the locking projection out of interaction with the projection of the load-receiving device.

According to another feature of the invention, the hinged ramps are connected through the use of traction cables to the barriers, so that the hinged ramps are swung up approximately vertically when the barriers are swung down, are swung up by approx. 45° when the barriers are horizontal, and are angled approximately horizontally or slightly downward when the barriers are swung vertically up.

According to yet another feature of the invention, the load-receiving device can be moved vertically relative to the guide body through the use of a motorized spindle.

Alternatively it can be provided that the guide body is mounted such that it can be transported along a first (lower) and a second (upper) guide rail and has a drive mechanism interacting with a drive rail, the drive rail being formed by a perforated bar, which in the longitudinal direction has regularly spaced engagement openings and two continuous, mutually opposing running surfaces, the drive mechanism having two gearwheel-like drive wheels, which are disposed in mutually opposing configuration and receive the perforated bar between them with a radial contact force, the drive wheels having drive surfaces which are continuous in the peripheral direction and radially protruding drive projections, the drive projections interacting with the engagement openings and the drive surfaces with the running surfaces in a form-locking and force-locking drive connection, and a housing carrying the drive wheels being held pivotably on the load-receiving device so that the course of the perforated bar defines the vertical situation of the load-receiving device relative to the guide body. A form-locking connection is one which connects two elements together due to the shape of the elements themselves, as opposed to a force-locking connection, which locks the elements together by using a force.

In this embodiment, it can further be provided that the perforated bar, in the region of stopping places and/or end points, is guided in the direction of the first (lower) guide rail.

According to another feature of the invention, a drive motor is fixedly attached to the load-receiving device and has a gearbox, the housing being held pivotably about a shaft.

Other features which are considered as characteristic for the invention are set forth in the appended claims.

Although the invention is illustrated and described herein as embodied in a stairlift for the disabled, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic side view of a stairlift according to the invention in a travel position, the platform, hinged ramps and barriers, as well as their actuating devices, being omitted for reasons of clarity;

FIG. 2 is a diagrammatic side view of a stairlift according to FIG. 1, the platform, hinged ramps and barriers, as well as the associated actuating devices, being represented and the drive being effected through the use of a perforated bar and drive wheels;

FIG. 3 is a view corresponding to FIG. 2, the vertical drive being effected through the use of a motorized spindle;

FIGS. 4, 5 and 6 are diagrammatic side views illustrating the interaction of a vertically movable barrier-actuating bar with a barrier;

FIG. 7 is a diagrammatic side view illustrating the interaction of a lifting bar for a barrier with a rotating stop on a pivot axle of a barrier; and

FIGS. 8 and 9 are diagrammatic side views illustrating the interaction of a tilt lever of the platform with a tilt stop.

### DESCRIPTION OF THE PREFERRED EMBODIMENTS

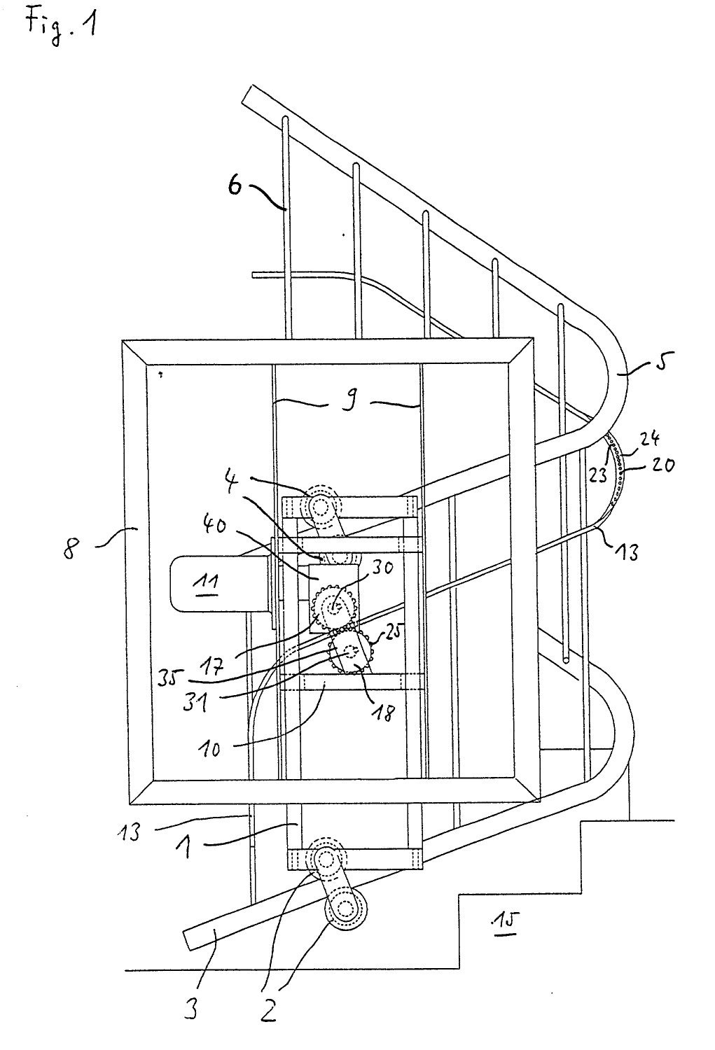

Referring now to the figures of the drawings in detail and first, particularly, to FIG. 1 thereof, there is shown a stairlift according to the invention, in which the platform and the barriers are omitted for representation reasons, at the foot of a staircase in a raised travel position, a guide body 1, represented as substantially frame-shaped, being transportably mounted and guided with lower guide rollers 2, provided in pairs, on a first, lower guide rail, and with upper guide rollers 4, provided in pairs, on a second, upper guide rail 5. In the represented embodiment, the guide rails 3 and 5 form together with vertical rods 6 a stair railing, the upper guide rail 5 serving as a handrail.

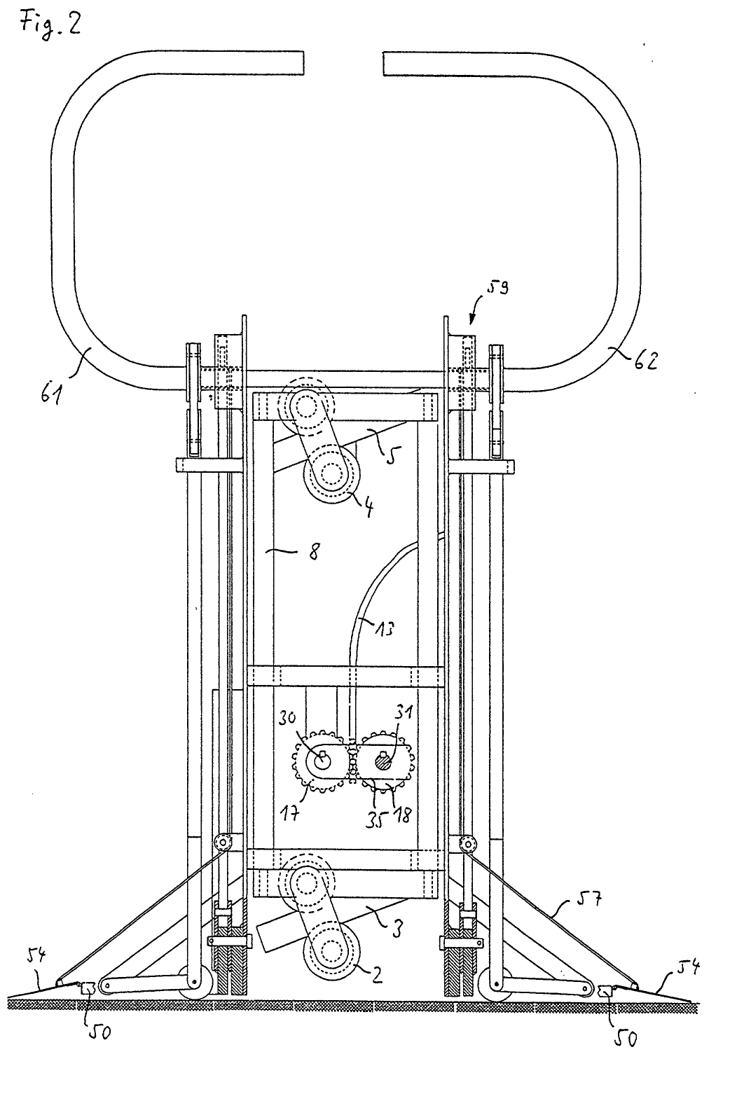

As can be seen from FIG. 1 and 2, a load-receiving device 8, which receives a load to be transported, is guided on the guide body 1 in a vertically displaceable manner, the load-receiving device 8 being provided, in the present case, with vertical guide struts 9 and cross-bars 10, on which a drive motor 11 and further drive elements, which are described below, are held.

A perforated bar 13, which is produced from a flat steel strip by punching-out of holes, is attached to the vertical rods 6 in a region between the guide rails 3 and 5 and runs essentially at a constant distance from or parallel to the guide rails, whereas, in the starting region of the lift in front of the lowermost stair 15 of the staircase, it is guided downward in the direction of the first guide rail 3 and, in its lower end region, runs approximately or completely vertically.

Flange-mounted on the drive motor 11 is a gearbox 40, on which a pair of gearwheel-like drive wheels 17, 18 are pivotably held, which receive the perforated bar 13 in form-locking and force-locking (positive and non-positive locking) connection between them.

The perforated bar 13 has on its top and bottom side, in each case adjacent on both sides to the holes or engagement openings 20, mutually opposing running surfaces 23, 24, with which the drive wheels interact.

The cylindrical drive wheels have inserted bolts 25, whose end sections protruding from the drive wheels are frustoconically tapered, the engagement openings of the perforated bar being correspondingly formed in double frustoconical configuration.

The drive wheels further have on their outer peripheral faces annular or cylindrical drive surfaces, which are respectively continuous laterally adjacent to the bolts in the peripheral direction and with which the drive wheels interact with the running surfaces.

The drive wheels 17, 18 are wedged in rotationally fixed configuration on shafts 30, 31, on which coupling gearwheels are likewise wedged in rotationally fixed configuration, so that the drive wheels are coupled together in terms of their drive, having the same rotation speed in opposite rotational directions. The shafts 30, 31 are mounted in a housing 35, one shaft being spring-loaded against the other and the contact force being able to be set such that, for example, 30% or even 50% of the drive force is transmitted by frictional engagement.

The housing 35 is held pivotably on a gearbox 40, so that the housing can perform a pivotal motion about the longitudinal axis of the shaft 30 and can hence follow a predefined course of the perforated bar 30.

FIG. 2 shows the load-receiving device 8 at the lower end point of its motion or in a lower end position, the drive mechanism including drive motor 11, gearbox 40 and drive wheels 17, 18, having been transported downward along the perforated bar 13. In a region in front of the lowermost stair 15 of a staircase, the load-receiving device 8 is thus in a position which enables a wheelchair or similar to be loaded or driven up onto a horizontal platform 50 of the load-receiving device.

In order to move the stairlift along the staircase, the load-receiving device 8 must initially be raised by a vertical height difference corresponding to the height of a or the lowermost stair 15 of the staircase, since the load-receiving device would otherwise butt against the stairs.

To this end, in a first motional section, the load-receiving device 8 is moved vertically upward, for which merely the drive motor 11 has to be activated, since the perforated bar 13 guiding the load-receiving device is correspondingly vertically guided. As soon as the drive wheels 17, 18 reach the curved transitional section of the perforated bar, the load-receiving device has also reached a sufficient height, so that the lift acquires a travel motion directed obliquely upward in accordance with the course of the perforated bar. The housing 35, holding the drive wheels 17 and 18, hereupon automatically pivots in accordance with the local inclination or curvature of the perforated bar.

Since the load-receiving device automatically and forcibly follows the course of the perforated bar, the guide rails 3, 5 can have a course which is practicable as a stair railing without having to pay regard to the motional course (lead) of the load-receiving device. In this case, the bearing frame in front of the first stair can be raised, for example, by 250 or even more, for example, 400 mm, which corresponds to a lowering of the guide rails relative to the load-receiving device by a corresponding measurement.

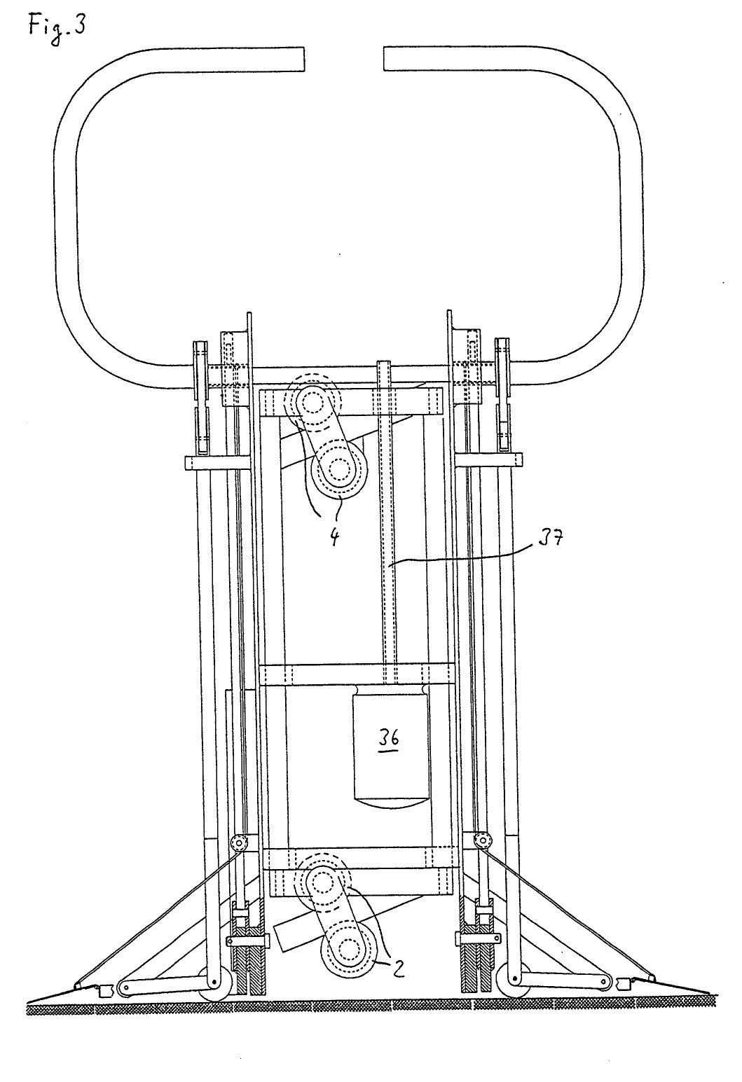

FIG. 3 shows an alternative embodiment of a stairlift, in which the vertical transport motion of the load-receiving device relative to the guide body is effected through the use of a threaded spindle 37 driven by a drive motor 36. The drive of the guide body can be effected, for example, directly by driving of the guide rollers 2 and/or 4.

For illustration of the further components necessary for the transport of a wheelchair-bound disabled person, such as platform, hinged ramps and barriers, reference should be made below to FIG. 2 and FIGS. 4 to 9.

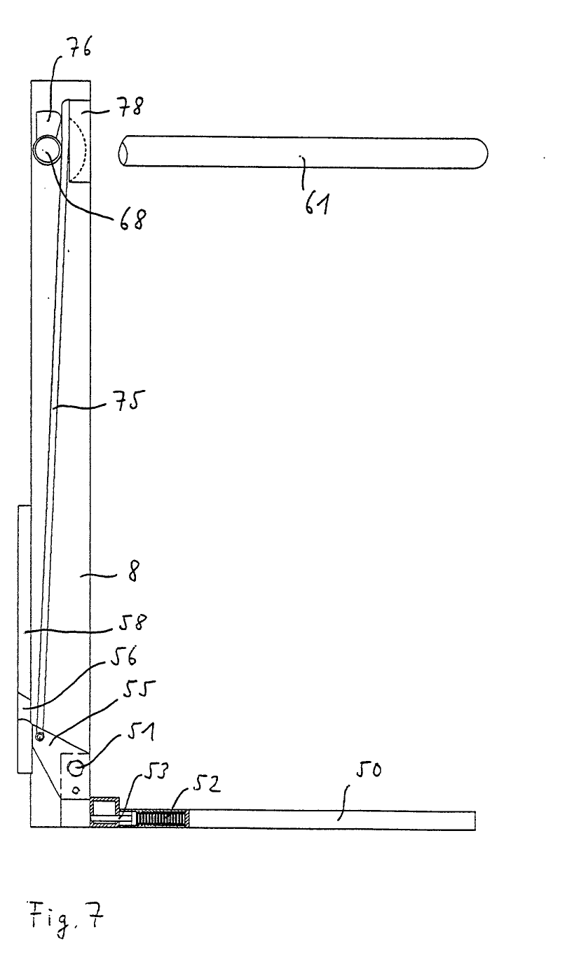

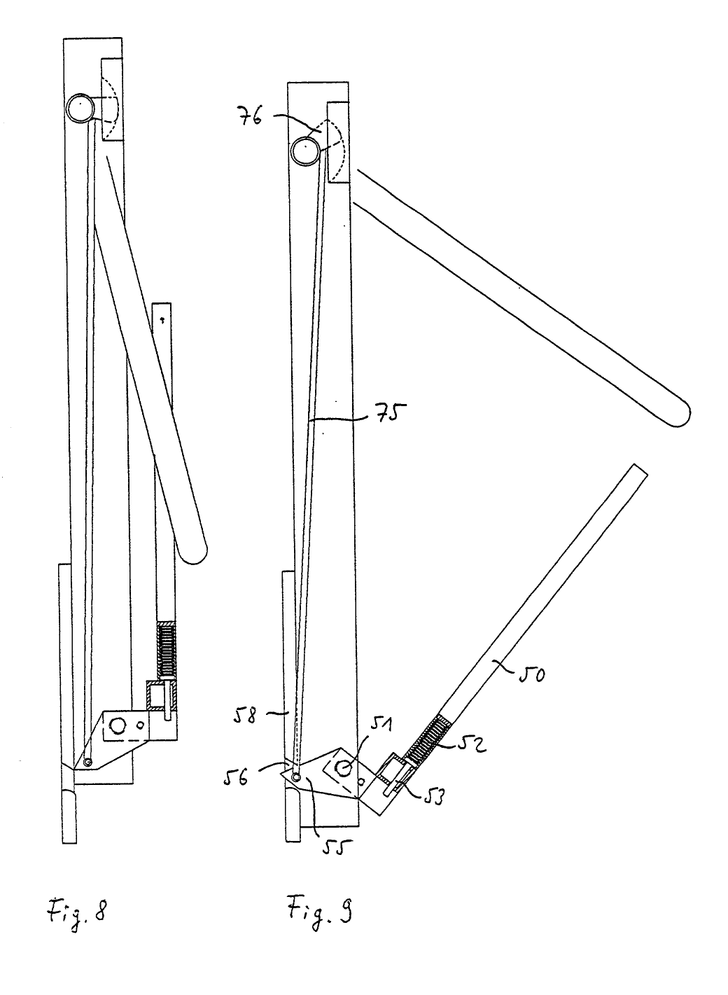

A platform 50 is pivotably fitted to the load-receiving device 8 and can be swung up between a substantially horizontal, laden (loaded) position and a space-saving vertical position. FIG. 7 shows the mounting of the platform 50 on the load-receiving device 8 in a diagrammatic side view, the pivotal motion being effected about a pivot axle 51. As further shown by FIG. 7, in the platform 50 there is disposed a stop bolt 53, which is pretensioned through the use of a spring (assembly of cup springs) 52 and which presses with a pretensioning force against the lower end section of the load-receiving device. This pretensioning device has the effect that, as the platform or load-receiving device 8 is elevated in the empty (unladen) state, the platform 50 is pivoted slightly upward as soon as a tilt lever 55 enters with its free end section or its tip into the region of an engagement opening 56 of a tilt stop 58 fixedly connected to the guide body 1, the effect being that, as the unladen (unloaded) load-receiving device 8 is further elevated relative to the guide body 1 and the tilt stop 58 fixedly connected thereto, the empty platform is pivoted up (intermediate position FIG. 9, end position FIG. 8). As shown by FIGS. 8 and 9, the then load-free stop bolt 53 has partially departed there from its guide in the platform 50.

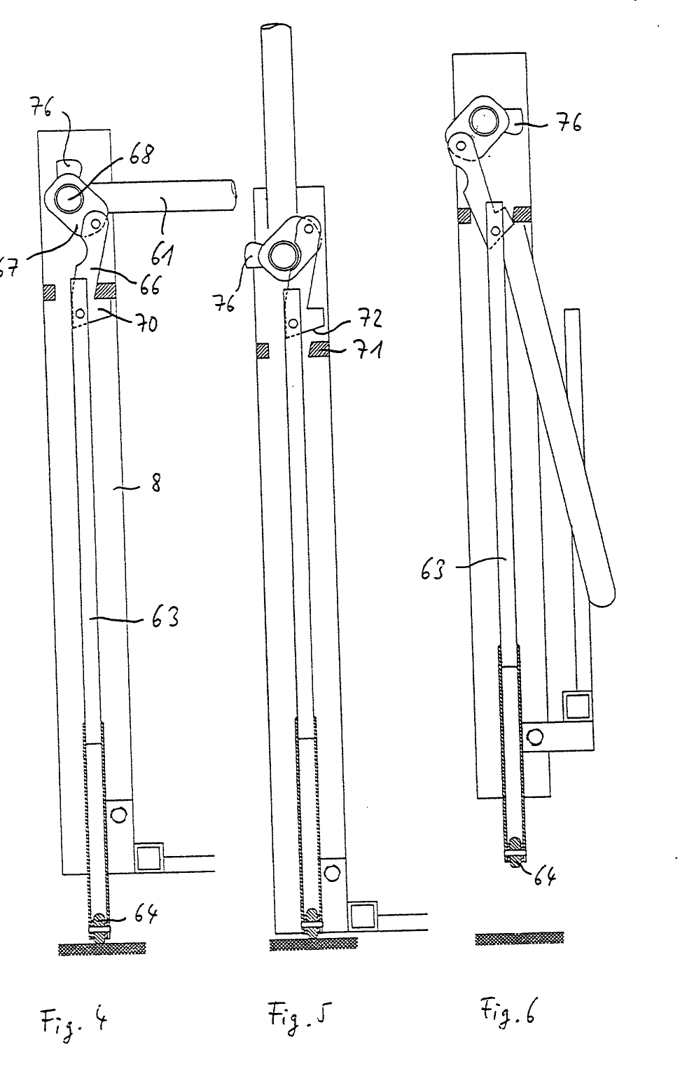

For illustration of the actuation of the barriers, reference should be made, in particular, to FIGS. 4 to 6. Two mutually independently movable barriers 61, 62 (FIG. 2) are present, in which the barrier disposed toward the ascending side on a staircase is referred to as the uphill barrier and the barrier disposed toward the descending side is referred to as the downhill barrier. At a stopping point of a stairlift at the lower end of a staircase, both barriers are expediently opened by being swung vertically upward, whereas at a stopping point at an upper end of a staircase only the uphill barrier, for safety reasons, can be opened, whilst the downhill barrier must remain closed. According to the invention, this is realized automatically as follows.

The load-receiving device accommodates two vertically movable barrier actuating bars 63, which in the travel position (FIG. 4: laden, FIG. 6: unladen) respectively protrude with an end section downward out of the load-receiving device and beyond, the lower end section of the barrier-actuating bars 63 expediently being provided respectively with a roller 64. As shown by FIG. 5, as the load-receiving device is lowered at a stopping point of the stairlift into the stopping position, through contact of the protruding end section or roller 64 with the floor, a barrier-actuating lever 63 is moved upward, so that the associated barrier 61 or 62 (or both) is swung up out of a horizontal position (FIG. 4) into a vertical position (FIG. 5). Since the end section of the barrier-actuating bar 63 assigned to the downhill barrier, when a stop is made in front of the upper end of a staircase, does not come into contact with the floor, the downhill barrier remains automatically closed.

The barrier-actuating bar 63 is connected at its upper end by an interposed locking bar 66 to a link lever 67, which, for its part, is fastened on a pivot axle 68 of the barrier. As further shown by FIG. 4 and 5, the locking bar 66 has a locking projection 70 for interaction with a corresponding projection 71 of the guide body 1, which, on its bottom side, is provided with a sliding slope 72, which, upon a downward-directed motion of the barrier-actuating bar 63, moves the locking bar past the locking projection 71.

As can be seen from FIGS. 7 to 9, linked to the tilt lever 55 of the platform 50 are two lifting bars 75, which interact with a respective rotating stop 76 on the pivot axles 68 of the barriers and a stop 78 fixedly fitted to the guide body 1 and serve to raise the barriers, as the unladen load-receiving device is lowered, out of the fully swung-down position of the barriers (FIG. 6) into the horizontal position (FIG. 7). As is further illustrated in detail, as the unladen load-receiving device is lowered the platform is swung up and the barriers swung down, as shown by FIG. 6, whereupon initially, prior to the barrier-actuating bars 63 making contact with the floor, the platform 50, through interaction of the tilt lever 55 with the engagement opening 56 of the tilt stop 58, is swung horizontally downward out of its vertical, space-saving position and, at the same time, both barriers are jointly raised by the lifting bars 75, in interaction with the rotating stop 76, out of their swung-down position into the horizontal position, an intermediate position within this process being shown in FIG. 9.

As further shown by FIG. 7, the lifting bars 75 are not fixedly connected to the rotating stops 76, but interact with these via the fixed stops 78, which are fitted to the guide body 1. This produces a clamping effect for the barriers in the horizontal position (FIG. 7), so that the barriers in this position are prevented both from being raised (as a result of the locking device formed from locking projection 70 and projection 71) and from being pressed down (due to interaction of rotating stop 76, lifting bar 75 and stop 78).

The sequence of functions (upward and downward, laden and unladen) is as follows:

1) Laden downward: the load-receiving device and hence the platform is lowered, in accordance with the course of the perforated bar 13 (or alternatively with the routing of the spindle 37), at stopping points or end points of the stairlift. The platform is initially horizontal, the barriers lie horizontally. After the roller 64 of one or both barrier-actuating bars 63 makes contact with the floor, one or both barriers 61 and/or 62 is/are swung upward. The locking action of the locking projection 70 is surmounted by virtue of the fact that, due to the angled-off configuration of barrier-actuating bar 63 and locking bar 66, a transverse force is generated at the connection point between the two bars, which transverse force moves the locking projection 70 away from the corresponding projection 71 (to the left in FIG. 4).

2) Laden upward: here the platform is initially horizontal, the barriers are swung vertically upward. The barriers move out of the position represented in FIG. 5, under their own weight, into the horizontal position, whereupon the locking projection 72 snaps in beneath the projection 71. Due to the interaction of the rotating stops 76 with the lifting bars 75 and the stops 78, the barriers are also prevented from being further swung down or pressed down (FIG. 7).

3) Empty upward: here the platform is initially horizontal, the barriers are swung vertically upward. When the platform is driven upward, the barriers move downward under their own weight (starting from the position according to FIG. 5) and snap in (FIG. 4). The spring 52 slightly raises the platform, through the use of the stop bolt 53, as soon as the tilt lever 55 enters with its tip into the engagement opening 56. Upon further raising, the tilt lever 55, through interaction with the engagement opening 56, is pivoted and moves the platform upward (FIG. 9). The lifting bars 75 are moved downward, so that a delayed release of the barriers comes about through the interaction of lifting bars 75 and rotating stops 76, and stops 78, and the barriers are swung downward over the platform (FIG. 8 and 6).

4) Empty downward: Here the platform is initially swung up, the barriers are swung down (FIGS. 8 and 6). The platform is moved downward, together with the load-receiving device 8, relative to the guide body 1. The tilt lever 55 makes its way into the engagement opening 56 (FIG. 9) and brings about a pivotal motion of the platform in the horizontal direction. At the same time, the barriers are moved out of the swung-down position by the lifting bars 75 and the rotating stop 76 into the horizontal position (FIG. 9). Following contact with the floor by one or both rollers 64, one barrier-actuating bar or both is/are moved upward, so that the respective barrier(s) is/are likewise swung vertically upward (FIG. 5).

The hinged ramps 54 (FIG. 2) are coupled by a suitable traction device, for example a traction cable 57 or a chain, and a corresponding reeling device 59 on the pivot axles 68 of the barriers fixedly with the swing motion of an associated barrier 61 or 62, so that a hinged ramp is in the horizontal or slightly downward angled position represented in FIG. 2 or 3 whenever the associated barrier 61 or 62 is in the vertically upward swung position, whereas the hinged ramp is in a position swung by about 45° upward when the corresponding barrier is lying horizontally, and is swung vertically upward when the barrier is swung completely downward.

A security device, which is not shown in the drawings, is provided against “unauthorized” raising of the barrier-actuating bar(s) 63 during travel so that, if this should happen, the lift immediately comes to a halt.

Furthermore, in a manner which is known per se, a trapping or catching mechanism is present, which, when a perforated bar 13 is used, can advantageously interact therewith.

In addition to the complexity (five drive motors) described in the introduction, according to the invention an additionally necessary locking of the barriers, all barrier and floor switches and all safety protections for the motors are also eliminated.

All that remains are one switch each and the by-pass circuit for monitoring the locks in the region of the stopping places in connection with early-opening barriers, similar to the case of early-opening doors of passenger elevators.

I claim:

1. A stairlift, comprising:
a guide body to be mounted such that said guide body is movable along a staircase;
a load-receiving device held in a vertically displaceable manner, said load-receiving device being movable between a lowered stopping position and a raised travel position;
a swing-up platform provided at said load-receiving device, said swing-up platform having two swing-up hinged ramps;
two barriers provided at said load-receiving device, said barriers having respective pivot axles, said barriers being separately operable and being configured as selectively downward-swinging and upward-swinging barriers;
two vertically movable barrier-actuating bars provided at said load-receiving device, said barrier-actuating bars having respective end sections protruding downward beyond said load-receiving device when said load-receiving device is in the raised travel position, and said barrier-actuating bars being linked to said pivot axles of said barriers;
one of said barrier-actuating bars being moved upward and swinging a corresponding one of said barriers up such that said corresponding one of said barriers swings out of a substantially horizontal position into a substantially vertical position when said load-receiving device is lowered into the lowered stopping position and a respective one of said end sections protrudes downward and makes contact with a floor;
a pretensioning device operatively connected to said swing-up platform, said pretensioning device forcing said swing-up platform upward such that, when said swing-up platform is raised out of the lowered stopping position, said pretensioning device brings said swing-up platform into an upwardly inclined, vacant position, if said swing-up platform is in an unloaded state;
said guide body having a tilt stop, said swing-up platform having a tilt lever disposed such that, when said swing-up platform is in an unloaded state and when said load-receiving device is one of raised into the travel position and lowered, said tilt lever interacts with said tilt stop of said guide body and swings said swing-up platform selectively up and down, and said tilt lever, when said swing-up platform is loaded and in the substantially horizontal position, remains disengaged from said tilt stop;
rotating stops disposed at said pivot axles; and
two lifting bars operatively linked to said swing-up platform, said lifting bars interacting with said rotating stops at said pivot axles of said barriers such that, when said load-receiving device is in an unloaded state and is lowered, with said swing-up platform initially being in a swung-up state and with said barriers initially being in a swung-down state, said lifting bars move said barriers into the substantially horizontal position as said swing-up platform is swung down.

2. The stairlift according to claim 1, including rollers respectively provided at said end sections of said barrier-actuating bars.

3. The stairlift according to claim 1, wherein said pretensioning device has a spring-loaded stop interacting with said load-receiving device when said swing-up platform is in a swung-down position, such that said spring-loaded stop forces said swing-up platform upward.

4. The stairlift according to claim 1, wherein said tilt stop is configured as an engagement opening for said tilt lever.

5. The stairlift according to claim 1, wherein said rotating stops are disposed on said pivot axles and offset by 90°relative to said barriers.

6. The stairlift according to claim 1, wherein said barrier-actuating bars have a locking device, said locking device is engaged when said load-receiving device is in the travel position and said locking device prevents said barriers from being raised when said barriers are in the substantially horizontal position.

7. The stairlift according to claim 1, including:
locking bars having respective locking projections;
said load-receiving device having projections interacting with said locking projections; and
said locking bars connecting said barrier-actuating bars to said pivot axles.

8. The stairlift according to claim 7, wherein:
said locking bars have respective sliding slopes; and
said sliding slopes move said locking bars past said projections of said load receiving device as said barriers are moved from a swung-up position into the substantially horizontal position.

9. The stairlift according to claim 7, wherein said locking bars, when said barriers are in the substantially horizontal position, assume an angled-off position relative to said barrier-actuating bars, such that, as said barrier-actuating bars are actuated, a transverse force is generated for moving said locking projections out of interaction with said projections of said load-receiving device.

10. The stairlift according to claim 1, including traction cables connecting said swing-up hinged ramps to said barriers, such that said swing-up hinged ramps are in a substantially vertical, swung-up position when said barriers are in a swung-down position, and such that said swing-up hinged ramps are swung up by substantially 45° when said barriers are in a substantially horizontal position, and such that said swing-up hinged ramps are angled one of substantially horizontally and downward when said barriers are swung vertically up.

11. The stairlift according to claim 1, including a motor-driven spindle for moving said load-receiving device vertically relative to said guide body.

12. The stairlift according claim 1, including:
a first guide rail and a second guide rail;
said guide body being mounted such that said guide body is movable along said first and second guide rails;
a drive rail formed as a perforated bar extending along a given course, said perforated bar defining a longitudinal direction and having engagement openings formed therein, said engagement openings being regularly spaced along the longitudinal direction, and said perforated bar having two continuous, mutually opposing running surfaces;
a drive mechanism interacting with said drive rail, said drive mechanism having two gearwheel-type drive wheels disposed opposite from one another;
said drive wheels receiving said perforated bar therebetween with a radial contact force, said drive wheels defining respective peripheral directions and having respective continuous drive surfaces extending along the peripheral directions;
said drive wheels having radially protruding drive projections interacting with said engagement openings in a form-locking drive connection;
said drive surfaces of said drive wheels interacting with said running surfaces of said perforated bar in a force-locking drive connection; and
a housing carrying said drive wheels and being pivotably held on said load-receiving device such that said given course of said perforated bar defines a vertical position for said load-receiving device relative to said guide body.

13. The stairlift according to claim 12, wherein:
said first guide rail is a lower guide rail and said second guide rail is an upper guide rail; and
said perforated bar having at least one point selected from the group consisting of a stopping point and an end point along the given course, and said perforated bar extending in a direction toward said lower guide rail at said at least one point.

14. The stairlift according to claim 12, including:
a drive motor fixedly attached to said load-receiving device, said drive motor including a gearbox; and
a shaft pivotably holding said housing.

15. The stairlift according to claim 1, wherein said load receiving device and said swing-up platform are configured for carrying a wheelchair-bound disabled person.

16. The stairlift according to claim 1, wherein said lifting bars are linked to said tilt lever.

17. The stairlift according to claim 1, wherein said lifting bars interact with said rotating stops at said pivot axles of said barriers such that, when said load-receiving device is in an unloaded state and is raised, with said swing-up platform initially being in a swung-down state and with said barriers being in a substantially horizontal position, said lifting bars move said barriers into a swung-down state as said swing-up platform is swung up.
